(19) United States
(12) Patent Application Publication
(10) Pub. No.: US 2003/0028491 A1
(43) Pub. Date: Feb. 6, 2003

(54) IMPROVED MONEY TRANSFER SYSTEM AND METHOD WITH ADDED SECURITY FEATURES

(76) Inventor: Jonathan D. Cooper, Topanga, California (US)

Correspondence Address: Perkins Coie LLP, Tamiz Khan, P.O. Box 2168, Menlo Park, California, 94026, US

(21) Appl. No.: 09/648,102

(22) Filed: Aug. 25, 2000

(51) Int. Cl. G06F 17/60

(52) U.S. Cl. 705/64

(57) ABSTRACT

### Abstract of Disclosure

Disclosed are improved computer systems and methods for money transfers completed by one-time use computer readable media for use in cash dispensing networks of computers (ATMs) as an alternative to a traditional wire transfer. In another embodiment a consumer may purchase these computer media at a third party location, which then allows the consumer to use it as portable electronic draft which substitutes for a traditional traveler 's check.

### FIELD OF THE INVENTION

The present invention relates to computer-implemented financial transactions, and more particularly to methods, systems and articles of manufacture to facilitate secure money transfers as an improved alternative to a traditional wire transfer.

### BACKGROUND OF THE INVENTION

### A. CONSUMER NON-BANK WIRE TRANSFERS

The national non-bank consumer wire transfer industry can be best described as a billion dollar industry, with rapid growth, high-profit margins and lack of competition. Consumers are hurt by this lack of competition, which is caused in part by market barriers. For example, a company wishing to establish a national wire business must first get the approval of 43 states. Not surprisingly, the wire transfer industry is controlled by a small group of companies each having tight control over their own conventional wire transfer system.

Prior Art Figure 1 illustrates a conventional wire transfer system 100. The conventional wire transfer system 100 includes a sender consumer 102, a recipient consumer 104, a wire transfer sending location 106, and a wire transfer recipient location 108. The typical sender consumer 102 is a friend or relative of the recipient consumer 104, and is willing to pay a substantial premium because the recipient consumer 104 needs money quickly. The recipient consumer 104 is generally a person who is in dire need of money.

In a typical wire transfer, the sender consumer 102, desiring to transfer money to the recipient consumer 104, physically enters the wire transfer sending location 106 in order to initiate a wire transfer to the recipient consumer 104. The recipient consumer 104 need not be present during the transfer of money from location 106 to 108, however, the recipient consumer 104 must go the physical location of the wire transfer center 108 and show the appropriate identification in order to receive the cash. The sending wire transfer center 106 usually charges a large commission for transmitting the transaction to the receiving wire transfer center.

Figure 2 is flowchart of the steps by which a traditional wire transfer is completed. In operation 202, the sender establishes contact with the wire transfer company by going to a physical location of the sending office or by telephone. In operation 204, transaction information is exchanged between the sender and the wire transfer company. In operation 206 the wire transfer company sending office informs the appropriate wire transfer company receiving office of the transaction information. In operation 208, the recipient goes to the physical location of the receiving office of the wire transfer company and shows appropriate identification in operation 210. The recipient then gets the cash from the transaction in operation 212.

As of 1995, Moneygram®, wire transfer service claimed there were over 33 million non-bank consumer money transfers per year worth about $9-10 billion dollars in the face amount of the transferred funds. Currently, consumers have only two large companies in the money wire transfer industry to choose from. Western Union®and Moneygram® earn substantial profits by charging a fee ranging from 7 to 11 % of the face value of each transfer. Currently, Moneygram®wire transfer service charges $24 dollars for a $300 wire transfer and Western Union®, a competing wire transfer service charges $30 dollars for the same wire transfer.

Although these two large money transfer companies will take money transfer orders by phone using a credit card, they are not currently actively promoting this service and most importantly, the consumer who is receiving the funds in a wire transfer must be at the office of a Western Union® wire transfer service or a Moneygram® wire transfer service (or one of their authorized agents)in order to pick up the transferred money. This is highly inconvenient for many consumers as the consumer must find an open Western Union office close to the physical location.

### B. PRIOR ART - ATM CARD USE AND ATM AVAILABILITY

There are over 165,000 Automatic Teller Machines (herein referred to as "ATMs") currently located in the United States, and there are over 400,000 ATMs in 110 countries located throughout the world. ATMs are no longer exclusively associated or located in or near banks and there are growing number of independent ATM network operators who are putting ATMs in more and more locations including grocery stores, casinos, tourist offices, and other places where people need instant access to their cash. In heavily populated urban or large commercial areas, there may be several competing ATMs in close proximity to each other. This is compared to currently only 15,000 Moneygram®and 28,000 Western Union® money transfer service locations in which to conduct a traditional wire transfer. The ATM networks provide 24-hour, 365 day access to consumers.

Figure 3 represents existing prior art for Automatic Teller Machine (ATMs) consumer usage for obtaining cash. A withdrawing consumer 302 goes to an ATM 304, places a computer readable medium 306, such as a magnetically encoded card ("ATM card"), into the appropriate console 308. The ATM then reads the ATM card, which then prompts the machine to connect the consumer to the appropriate financial network and/or bank, 310 and 312 (respectively). The consumer is usually prompted to enter a security code on a keypad 314, which is the sent to the financial network's computers for verification. The withdrawing consumer is then offered a variety of menu options depending on what type of account to which the ATM card has access. Virtually all ATMs are connected to a series of national networks from which a consumer can access their credit, checking or savings accounts.

There are other reasons that consumers prefer ATMs over items like checks or credit cards. Many consumers do not qualify for or simply will not use credit cards, because of the high interest and/or revolving debt problems. Most retailers are hesitant to accept checks and some only accept them with a great ordeal, such as a thumbprint, while others will not accept checks at all.

Other options involve using an ATM debit card that utilizes the Visa®, Mastercard®, or NYCE®system, which draws on a consumer's existing savings or checking accounts (herein referred as a "checkcard"). This is also often an unacceptable alternative due to safety concerns and potential fraud. A person could lose the entire amount of money contained in a checking or savings account because of susceptibility to fraud or theft of their account numbers when using they use their checkcards. Even though many retail transactions using checkcards require the input of a 4-digit (or 6-digit) unique security identifier, the 4-digit unique security identifier can be easily memorized by an errant clerk or other potential thief to access the money in the account. Recent news stories, include clerks at upscale retail stores who steal these numbers and sell them to professional thieves.

A large segment of the population does not have access to a standard checking account from which they can use a standard ATM card or "Checkcard" system to access their cash. These consumers may have poor credit, or are uncomfortable and unfamiliar with traditional banks, and are unable to use the standard banking system. Some of these consumers simply may not trust banks as is often the case with many elderly people who lived through the Great Depression. Often these consumers lack a desirable method by which to travel with large amounts of money without exposing themselves to the tremendous risks involved with carrying cash.

Additionally, even though consumers have access to credit cards or checkcards, they prefer to deal strictly in cash, but do not like the safety concerns present by carrying large amounts of cash. Even consumers who have credit cards or checkcards could purchase a one time use electronic draft that would act very much like that of the current use of one-time use phone card with heightened levels of security to insure both the protection of the consumer and the consumer's bank account.

### OTHER PRIOR ART: EDS

Electronic Data Systems (EDS) currently owns a system (US Pat No. 5,650,604, see figure 4A) which allows a funds transfer in which a recipient consumer can withdraw cash at an ATM given only a security code and a unique security identifier and such withdrawals can be made without the use of an ATM card. However, due to security risks associated with this system and the limited availability of ATMs that are adapted for this particular system, (since most ATMs are activated by the insertion of a magnetically encoded card) this method is neither safe for the sender or recipient, nor commercially viable to date. This system also requires the recipient consumer to remember two sets of security identifiers.

There are other concerns, such as destruction or forcible robbery with current ATM usage addressed by the one time use security feature. For example, a withdrawing consumer may be denied access to the money in their account due to demagnetization. ATM cards can be demagnetized over time or instantaneously by airport scanners or other technological sensing devices. In other cases, ATM cards are valid for several years, but wear out, crack or become inoperable as a result of other mishaps like immersion in water, which means that a bank customer would not have access to needed cash at a critical time. The longer an ATM card is used the greater the chance of failure. Often card replacements are available only during bank business hours for which banks charge a small fee.

Some consumers are completely dependent on ATM cards which makes them susceptible to breakage or demagnetization from repeated usage, forcible robbery or kidnapping, where a victim is compelled to withdraw all the money in their bank account. In these cases, the current ATM card technology fails the customer who will feel more comfortable using the present invention as a temporary measure for obtaining cash. This is especially relevant since ATM cards can only be replaced during business hours.

### C. IMPROVED AVAILABILITY FOR PORTABLE ELECTRONIC TRAVELER@$apos;S CHECKS

Figure 4 illustrates the current existing prior art method 450 for traveler's check transactions and redemptions. In operation 452, a purchasing consumer desiring a financial transaction instrument which has improved safety over cash or credit cards, goes to the physical location of a commercial bank or credit card union or traveler's check office to purchase a traveler's check. In operation 454, the consumer generally exchanges cash for a series of paper drafts, which have pre-determined denominations, of 10, 20, 50, 100, or 500 dollars. In operation 456, the purchasing consumer is charged a commission of 1 to 3 percent depending on the traveler's check retailer. The purchasing consumer is usually then instructed to sign one line of each check right in the purchasing location and then instructed to save the receipts in operation 458, in the event of theft or loss.

In operation 460 in order to redeeming the traveler's check, a consumer goes to the physical location of a commercial enterprise or bank or traveler's check office. In operation 462, the consumer signs the traveler's check in the presence of the cashier, who then exchanges the traveler's check for local currency.

If a traveler's check is lost or stolen in operation 470 a consumer who has lost or has had traveler's checks stolen, takes the receipts to the physical location of a traveler's check redemption office. In operation 472, the consumer then presents the receipts to customer service personnel, fills out the appropriate forms and is usually given replacement checks on the spot in operation 474. Often the consumer's complaint is verified and the checks are delivered to the physical location of the consumer in operation 476. However, the consumers often face severe difficulty in replacing the checks if they lose the traveler's check receipt, or if they cannot find an office that is open or convenient.

Consumers generally carry travelers' checks to improve safety, convenience, and economy over carrying cash or credit cards (which often charge up to 23% interest as well). Several large financial service companies offer such checks for which they charge a small commission of 1-3 % of the face value of the check. Although these checks are far superior to cash in safety, they have serious limitations.

### A. MEDIUM OF EXCHANGE

Consumers of traveler's checks can take them anywhere, but are often confronted with the fact that a retailer will not accept them (for one reason or another), or have trouble cashing them, particularly in a foreign country where traveler's checks are often only cashed by banks or check exchanges which keep limited and often bizarre hours.

### B. DESTRUCTABLE

Traveler's checks are made out of paper, which is susceptible to destruction by water, washing machines, etc. The advantage of carrying a medium which has the same benefits as a traveler's check (portability, universal exchange at any ATM, etc.), but is not susceptible to easy physical destruction presents a superior alternative to the currently existing paper draft technology.

### C. FRAUD

A good forger can learn to mimic a signature in a matter of minutes, and while consumers are often protected in the long run, they have to find an American Express®, Thomas Cook® or other traveler's check office to get their checks replaced. If the consumer is in a place where there is no office available, the traveler can be highly inconvenienced and possibly subject to danger.

### D. EXCHANGE RATE ADVANTAGES

Additionally, currently users of traveler's checks must make sure that the denomination of traveler's check is in the local currency in order to cash the check. Even though the implementation of the Euro in Western Europe has eased this problem to a few popular international tourist destinations, there is still considerable difficulty associated with exchanging currency as consumers must find an open currency exchange where they usually pay a substantial fee to exchange one form of currency for another. Current ATM technology allows a consumer to purchase or withdraw money in the form of local currency at a favorable exchange rate from any ATM overseas. A universal card that would allow for a one-time ATM withdrawal in local currency would solve the currency exchange availability problem.

Often a consumer is in a foreign country and does not have correct traveler's checks for that country's currency. If a consumer could withdraw cash at a foreign ATM, instead of having to cash a traveler's check at an exchange office, the amount withdrawn is automatically converted from US dollars (or other currency) by a conversion process, usually at a rate far more favorable than exchange office or merchant would offer if they would cash the traveler's check at all.

### E. ATM AND PURCHASE AVAILABILITY OF TRAVELERS

Additionally consumers have to purchase travelers checks at a bank or travel office and these services are often only available during daylight hours on the weekdays. Purchasing consumers desiring a safe portable transactional device, do not have system by which they can go a local drug store or 24-hour convenience store (for example, 7ELEVEN®) before a long trip to get secure transactional devices that provide them the security provided by traveler's checks.

### PRIOR ART: VISA TRAVEL MONEY

VISA® currently allows its customers, through participating banks, a service which allows them to go to the bank during business hours to purchase an ATM card which contains a preset amount of money. This card acts like a pre-paid VISA® at participating retailers and ATMs and provides some of the advantages over the traditional traveler's checks, such as security, 24-hour ATM availability and less destructibility, but also has drawbacks as well.

First, like traveler's checks, the VISA®travel money product can only be purchased at participating banks or retailers during business hours, thus limiting the availability of this product. The present invention is a substantial improvement because it is easily purchased, 24 hours a day, 7 days a week by consumers who need a safety cash-substitute product on short notice. This availability of the present invention applies to the gift aspect of the pre-paid ATM card as well. The targeted pool of consumers who use this product are often urgently in need of a safe travel financial mechanism and arranging purchase during business hours at certain banks (which may not be located in smaller cities or rural areas) is highly impractical.

Secondly, this product is multiple use and up to $10,000 can be put on one card. Thus the loss, theft, or demagnetization of one card can leave a consumer in a precarious position, with all $10,000 at risk. A one-time use ATM card provides an improvement over this prior art system simply because only a limited amount of cash is at risk. A consumer can simply take a one time use card for shopping or the casino and not worry about risking losing more than the prepaid amount.

### BRIEF DESCRIPTION OF THE DRAWINGS

The invention, together with further advantages thereof, may best be understood by reference to the following description taken in conjunction with the accompanying drawings in which:

Figure 1 illustrates the prior art involved in the current consumer-to-consumer wire transfer transaction method.

Figure 2 illustrates the flowchart of the prior art involved in a conventional consumer-to-consumer wire transfer.

Figure 3 illustrated the prior art in conventional consumer ATM consumer network usage.

Figure 4 flowcharts the prior art involved in a traveler's check purchase and use or exchange.

Figure 5 illustrates the proposed invention in its first embodiment, an improved consumer to consumer money transfer method (utilizing one time use configured computer readable medium).

Figure 6 illustrates the process by which an improved consumer-to-consumer money transfer method is completed.

Figure 7 illustrates the proposed invention in another preferred embodiment, an, an improved consumer to consumer money transfer method (utilizing one time use configured computer readable medium) using a third party commercial vendor as a deployment (transaction fulfillment) center.

Figure 8 illustrates the process by which the steps by which the invention embodiment in figure 7 may be completed.

Figure 9 illustrates the proposed invention in another preferred embodiment, a portable electronic draft using a configured computer readable medium, distributed by a third party commercial vendor network.

Figure 10 flowcharts the steps by which the embodiment of the invention as embodied in illustration 9 may be completed.

Figure 11 represents a possible configured computer readable medium, which can be utilized in the invention.

Figure 12 represents a computer readable medium reader, which can be attached to a computer with a CPU, mouse, keyboard, and monitor.

Figure 13 represents one possible workstation for the transaction control center in which a personal computing device (which may be a personal computer with a CPU or a terminal connected to the main computer).

Figure 14 represents the central computer system attached peripheral computers and financial networks as one possible configuration necessary for the implementation of the current invention.

Figure 15 represents an Automatic Teller Machine (ATM) connected to financial networks.

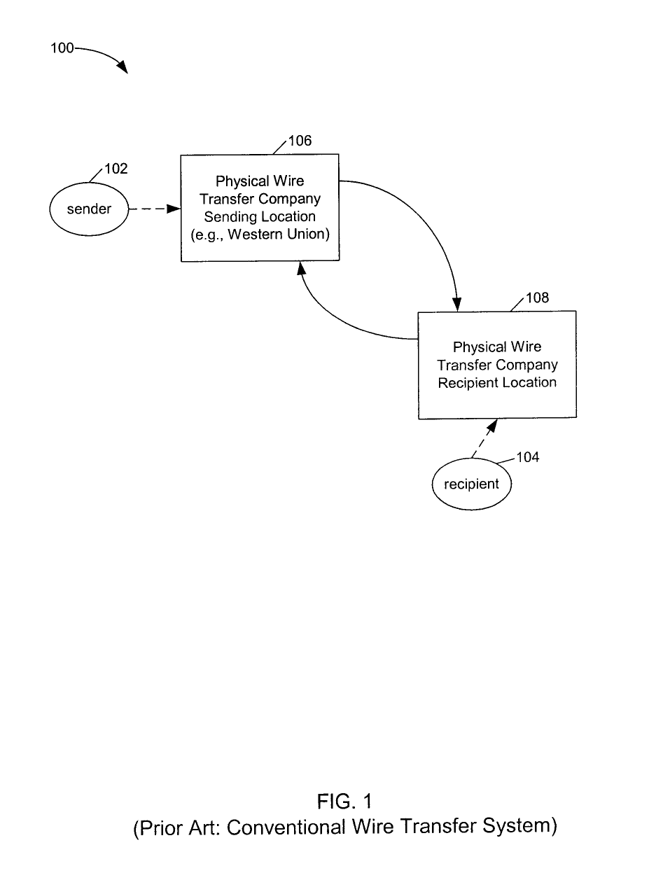

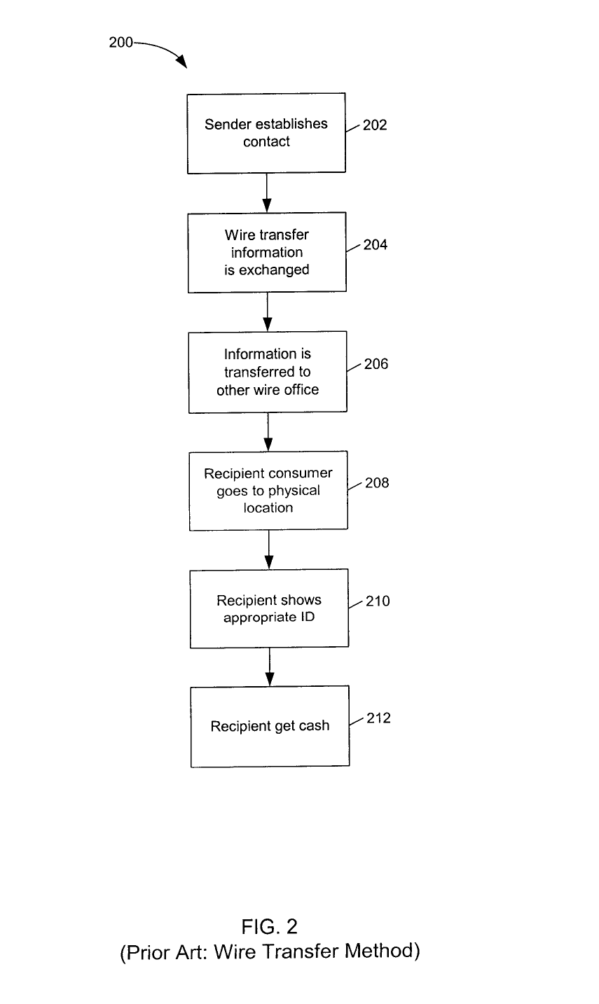

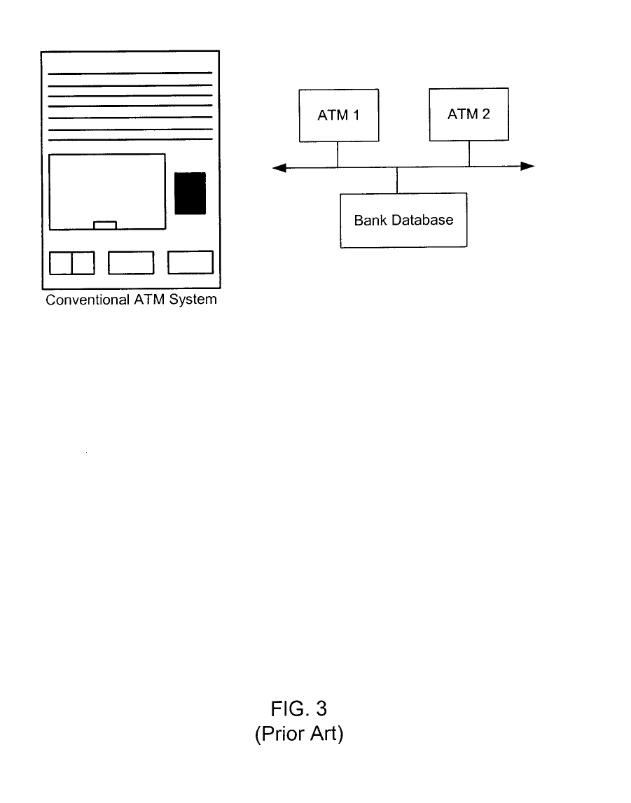

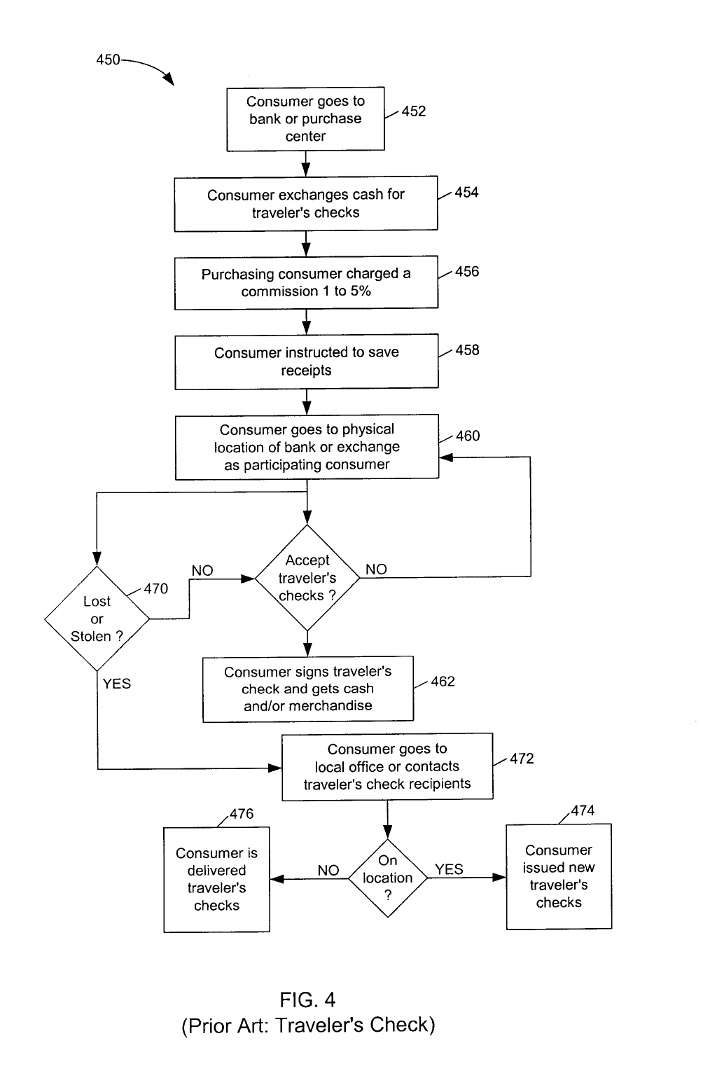

### DETAILED DESCRIPTION OF THE INVENTION

A process, and systems and articles of manufacture useable in said process are described herein that facilitate the secure and reliable money transfers among or by consumers, including via third party vendors. The inventions described herein accomplish said money transfers using single use readable computer media which incorporate added security features, for use as an alternative to traditional wire transfers. An invention for a one time use portable electronic draft, which is an improved alternative to traditional traveler's checks is described as well.

In the following description, numerous specific details are set forth in order to provide a thorough understanding of the present invention. It will be apparent, however, to one skilled in the art, that the present invention may be practiced without some or all of these specific details. In other instances, well known process steps have not been described in detail so that the present invention is not unnecessarily obscured.

### PREFERRED EMBODIMENT: Computer Oriented Business Method for an Improved consumer money transfer using a configured computer readable medium (as an alternative to wire transfer).

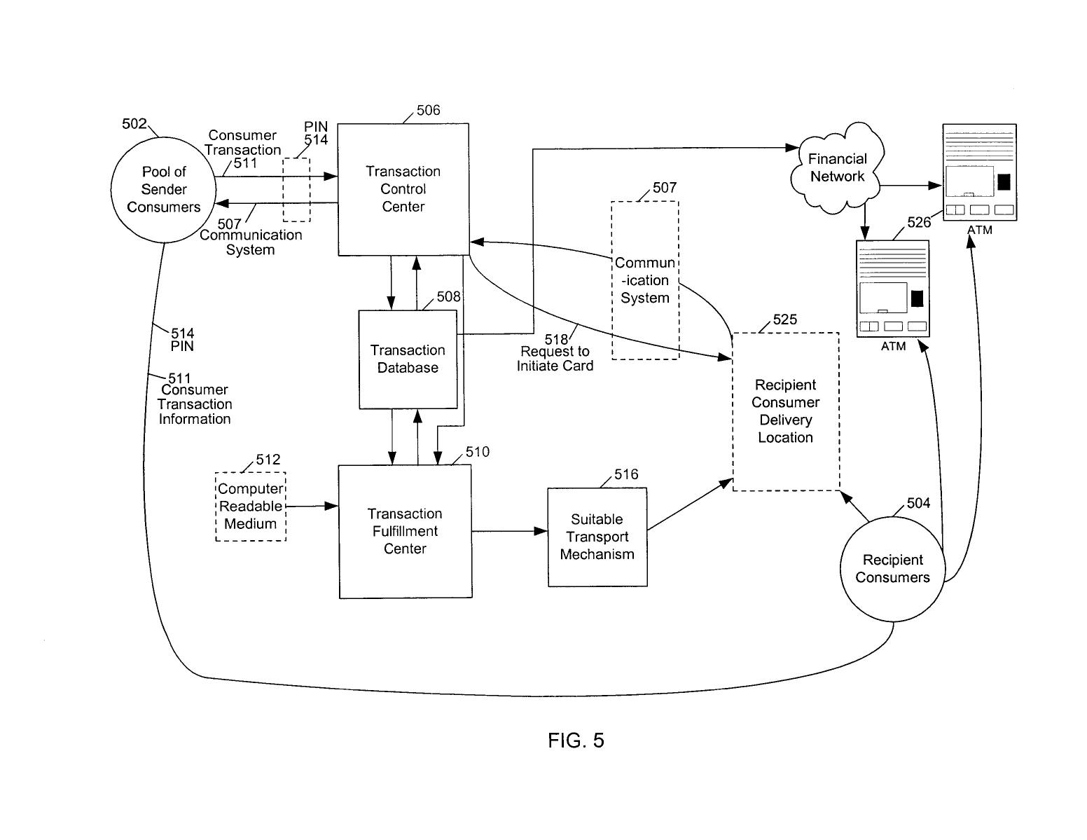

Referring now to Figure 5, which is an illustration of a computer system 500 for enabling an improved secure consumer wire transfer using a configured computer readable medium between potential pools of sender consumers 502, and pools of recipient consumers 504, including a transaction control center 506, a consumer communications system 507, a transaction database 508, a transaction fulfillment center 510, a configured computer readable medium 512, a security code 514, a suitable transport mechanism 516, and a network of cash dispensing devices 526. An optional feature includes a network of delivery locations at participating third party commercial vendors 525.

Data exchanged between sender consumer and the transaction control center includes: consumer transaction information 511, a unique security identifier 514. Data exchanged between the recipient consumer and the transaction control center includes a verification request 518. Please note, the sender consumer and recipient consumer may be the same person. A computer readable medium 512 is pre-encoded as described in the method embodiment below.

A sender consumer 502 wishes to send money to a receiver consumer 504 via the method of a secure money transfer as an alternative to a traditional wire transfer. The sender consumer 502 contacts the transaction control center 506 via a consumer communication system, 507, which may be embodied as a standard telephone communication, such as a vanity 1-800 number, or communication via a global computer network (herein referred to as the "web page"). The sender consumer 502 then informs the transaction control center 506 that they wish to send a specific amount of money to the receiver consumer 504.

The transaction control center 506 then records the sender consumer's transaction information 511 such as, but not limited to name, amount of transaction, credit card number, and the name and delivery address of the intended recipient into the transaction database 508. The transaction control center 506 then inquires to the sender consumer 502 as to what unique security identifier 514 they wish to set for the secure wire transfer completion. The unique security identifier 514 is entered into the transaction database 508 as well.

The sender consumer 502 is then informed by the transaction control center 506 that they need to contact the receiver consumer 504 by telephone or other appropriate communication method and notify them of the unique security identifier 514, and other relevant information, such as the amount. The credit card transaction between the sending consumer 502 and the transaction control center 506 is verified by the transaction database 508.

The transaction control center 506 then transfers the sending and receiving customers' information to the transaction fulfillment center 510 which then transfers a one-time use only configured computer readable medium 512, with the appropriate account information stored on said medium, to an suitable expedited transport mechanism 516. Ideally, the suitable expedited transport mechanism 516 is an overnight courier, but for alternate delivery methods, a suitable transport mechanism 516 may have several different embodiments particular to the transaction and is used as an example only.

The one time use only configured computer readable medium, 512, is transported to the delivery address of the recipient consumer contained in 511, assigned by the sender consumer 502 by the suitable expedited transport mechanism 516.

An optional feature of invention includes a security system that allows activation upon verification of the receipt of the card. After receipt of the configured computer readable medium 512 the receiver consumer 504 then contacts the transaction control center 506 via suitable consumer communication device, such as a l-800 number or via the web page 518 and verifies with the transaction control center, 506, that they have received the configured computer readable medium. The transaction control center then sends an activation signal or code 520 to the transaction database 508, which then enables the configured computer readable medium to be used by a network of ATMs 526 or other cash dispersion devices.

Another optional feature of the invention includes a network of third party commercial vendors 525 which act as a predetermined location for delivery for the recipient consumer. This is particularly suitable for recipient consumers who may be traveling or not have a viable delivery address for the suitable transportation mechanism 516. Ideally, the third party commercial vendor 525 is open 24 hours, has a phone capable of making a toll free telephone call or other suitable communication system 507, and an ATM 526 in order to fulfill the transaction.

The recipient consumer can now use the configured computer readable medium 512 at an ATM 526 to withdraw the cash transferred in the secure money transfer. The withdrawing consumer enters the unique security identifier 514 communicated to him by the sender consumer when prompted by the ATM 526 or other cash-dispensing device, in order to withdraw the transferred funds. During usage of the configured computer readable medium 512 at the ATM or other cash dispersion device, the withdrawing consumer is reminded that the configured computer readable medium is one use only and all the cash in money transfer assigned to the recipient consumer's particular configured computer readable medium (for example they could have two $300 ATM cards) is presented during the withdraw. The withdrawing consumer then discards the configured computer readable medium 512 appropriately.

The exemplary computer system 500 of Figure 5 is for descriptive purposes only; it may be provided by a microcomputer, a MACINTOSH®or PC server running a WINDOWS NT®, LINUX, UNIX®, or an APPLE® platform. The description is not required to restrict the inventor to one particular form of computer system by which this system would be implemented, but used to illustrate the embodiment.

### COMPUTER METHOD FOR PREFERRED EMBODIMENT

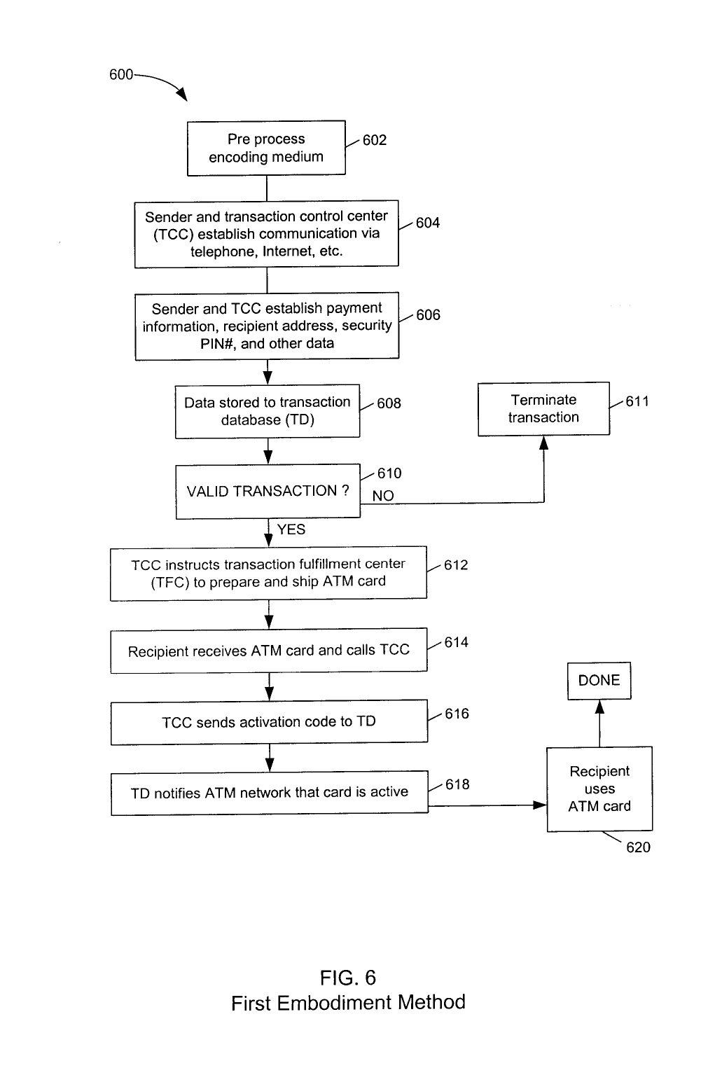

Referring now to Figure 6, which is a flowchart of a computer-implemented method for completing an improved secure consumer to consumer money transfer. In an initial operation 602, pre-method operations are completed. These operations may include the transferring of computer data to a computer readable medium as to enable to the computer readable medium to be utilized by a transactional database connected to an appropriate computer medium reading device that allows the computer readable medium to be read by a network of cash dispensing devices including ATMs.

In step 604, the sender and transaction control center establish communication. Such communication may be established audibly via a telephone line, over the Internet, or by any other appropriate means. In step 606, the sender and transaction control center exchange consumer transaction information, including, but not limited to the amount, sender consumer's credit card number, unique security identifier, and delivery address for recipient consumer.

In the operation 608, contact information for said recipient consumer; purchasing information from the sender consumer, the unique security identifier associated with said secure wire transfer is entered into a transaction database along with other necessary and optional data. The transaction database assigns a configured computer readable medium to the particular money transfer transaction, informs the control center of the operation, and stores the information on the database for possible later activation.

The credit card transaction is verified by the transaction database in 610. If the transaction is not valid (cancelled card, over credit limit, etc.) the transaction is terminated at step 611. If the transaction is valid, in step 612 the transaction database informs the transaction fulfillment center or the transaction control center that the transaction was valid. The configured computer readable medium is shipped to the appropriate location for the recipient consumer.

An optional additional security system of the invention allows for verification of the configured computer readable medium in order to activate the card. In optional step 614 the recipient consumer receives the configured computer readable medium and contacts the transaction control center and informs them that they have received the configured computer readable medium. In optional step 616 the transaction control center activates a program that notifies the transaction database that the correct recipient consumer has received that configured computer readable medium and that the configured computer readable medium should be activated.

In operation 618 the configured computer readable medium is activated via the transaction database, when the transaction control center receives a request from the recipient consumer to activate the card. In operation 620 the transaction database then informs a participating financial computer network that the configured computer readable medium is active, which allows the recipient consumer to withdraw cash from ATM networks at their convenience.

Those of ordinary skill in the art should readily appreciate that the computer code that generates, defines, stores and retrieves the data required for this transaction, including, but not limited to the financial transaction data, security data (unique security identifier), and the optional activation code can be delivered to the computer in many forms, including, but not limited to: (a) information permanently stored on non-writable storage media (e. g., read only memory devices within a computer or CD-ROM disks readable by a computer I/O attachment); (b) information alterably stored on writable storage media (e. g., floppy disks and hard drives); or (c) information conveyed to a computer through communication media such as telephone networks and LANs. It should be understood, therefore, that such media, when carrying such information, represent alternate embodiments of the present invention.

### ALTERNATE PREFERRED EMBODIMENT: Computer Oriented Business Method for an Improved consumer money transfer using a configured computer readable medium (as an alternative to wire transfer) utilizing third party commercial vendor networks.

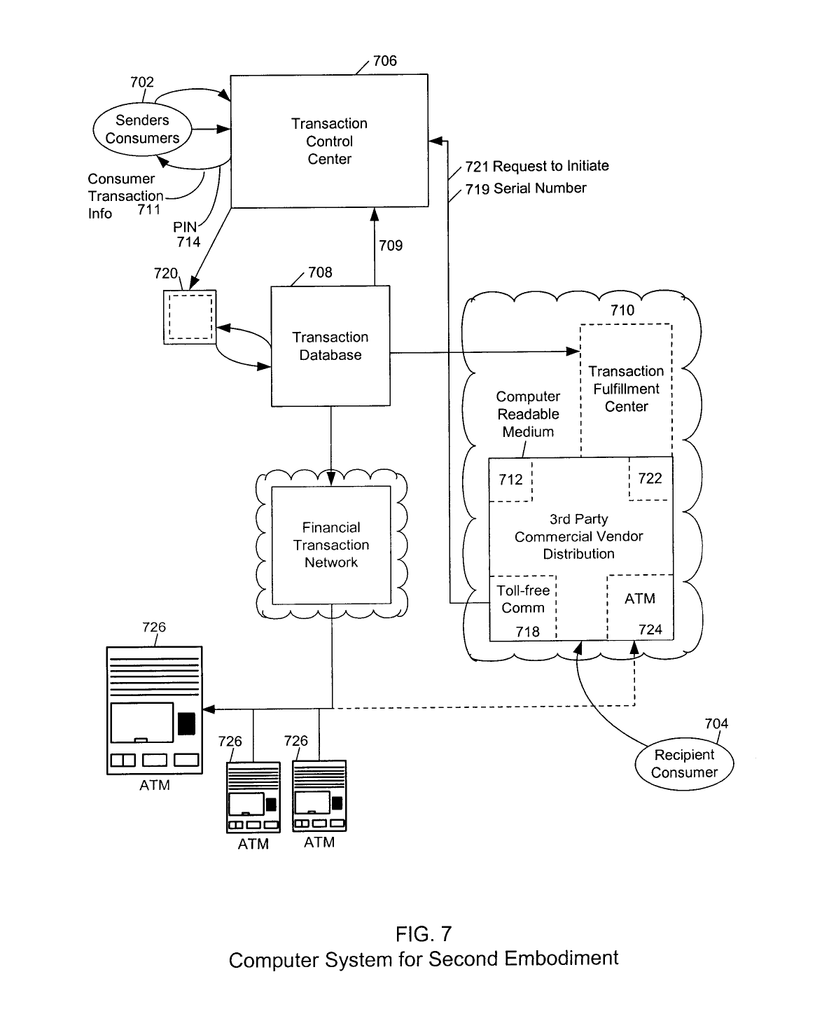

Referring now to Figure 7, which is an illustration of a computer system for enabling an improved money transfer method utilizing a one time use only configured computer readable medium as an alternative to a traditional wire transfer, using a network of third party commercial vendors as the delivery mechanism for the configured computer readable medium.

Computer system 700 enables an improved secure consumer money transfer using a configured computer readable medium consisting of a transaction control center 706, a consumer communications system 707, a transaction database 708, a configured computer readable medium 712, a unique security identifier 714 a network of predetermined pick up sites of third party commercial vendors 722, which is ideally open 24 hours a day, 365 days a year and has an on location pay phone, which will make toll free call, and cash dispensing device 726, such as an ATM connected to a financial computer network. In this embodiment, these third party commercial vendors will act in the capacity of the transaction fulfillment center 710.

Please note, there is nothing in the invention which prevents the sender consumer and recipient consumer from being the same person. This is particularly noteworthy as this embodiment allows the purchase of the configured computer readable medium at the third party vendor location as a gift money card.

Data exchanged between sender consumer and the transaction control center includes: consumer transaction information 711 a unique security identifier 714 pick up location criteria 713 and an optional pick up password 717. Data received from the transaction server includes delivery location appropriateness and availability 709. Data exchanged between the recipient consumer and the transaction control center includes a verification request 718 via communications system.

A sender consumer 702 wishes to send money to a receiver consumer 704 via the method of a secure money transfer as an alternative to a traditional wire transfer method. The sender consumer contacts the transaction control center 706 via a consumer communication system 707 which may be embodied as a standard telephone communication, such as a vanity 1-800 number, or communication via a global computer network (referred to as the Internet). The sender consumer then informs the transaction control center that they wish to send a specific amount of money to the receiver consumer with configured computer readable medium pickup at the third party commercial vendor network site and the unique security identifier 711 and other necessary and optional information to the transaction 714. As an optional feature of this patent, if a sender consumer believes that a recipient consumer will be unable to present suitable identification to the third party location to pick up the card or would like added security, they may request a pick-up password 717.

The transaction control center then inquires of the sender consumer as to the geographic location where the recipient consumer will be located with as much specificity as possible 713. The transaction control center then inputs this data into the transaction database 708 which then returns data 709 to the transaction control center as to the closest or otherwise most appropriate location to the intended recipient consumer of a third party commercial vendor site and an optional pick up password 717. Appropriateness of the location may be determined by other factors requested by the sender consumer, these may include safety, convenience, access to an ATM, etc.

The transaction control center then enters the sender consumer's transaction information 711, and the unique security identifier 714 into the into transaction database 708.

The sender consumer is then informed by the transaction control center that they need to contact the receiver consumer by telephone or other appropriate communication method and give them the unique security identifier 714 appropriate pick-up location of the configured computer readable medium at the third party commercial vendor network location 709 and optional pick up password 717 and other optional information, such as amount of the transaction. The credit card transaction between the sending consumer and the transaction control center is also verified by the transaction database.

The transaction control center then transfers the sending customer's information to the virtual transaction fulfillment center 710. This transaction fulfillment center may be located at the physical location of the third party commercial vendor network 722 site where the configured computer readable medium 712 may be acquired or be virtually located in any appropriate location.

As an optional feature of the patent, if the receiver consumer has not picked up the configured computer readable medium 712 a preset amount of time after delivery the third party commercial vendor will notify the transaction control center that the recipient consumer has not picked up the configured computer readable medium and the transaction control center credits the unused portion of the money back to the sender consumer.

The recipient consumer goes to the third party commercial vendor 722 and picks up the configured computer readable medium 712. As an optional feature to the invention, when the consumer receiver arrives at the third party commercial vendor location 722 they may pick up the card when they present the agreed upon password 717 to retrieve the configured computer readable medium 712

Upon receipt of the configured computer readable medium, the receiver consumer then calls a toll free number via a telephone 718, which ideally is at the physical location of the third part commercial vendor 722, and verifies with the transaction control center 706 that they have received the configured computer readable medium 712. An optional feature allows the recipient consumer to contact the transaction control center via the Internet or other appropriate communication device 707. The transaction control center 706 then merges the information sending consumer's transaction information 711 with the configured computer readable medium 712.

As an alternate, the third party commercial vendor 722, may have a dedicated phone or other communication 718 by which the recipient consumer can activate the configured computer readable medium 712 through the transaction control center 706.

The transaction control center then sends an activation signal 720 to the transaction database 708, which enables the configured computer readable medium 712 to be used by a network of ATMs 726 or other cash dispersion devices by merging the configured computer readable medium information 712 with the transaction information 711.

Ideally, as an alternative embodiment, the third party commercial vendor site 722 will have an ATM 726 on site, facilitating the ability to complete of the money transfer, and potentially increasing revenue for the third party commercial vendor due to convenience purchasing by the recipient consumer 704. However, this is not a necessary part of the invention.

The recipient consumer 704 can now use the configured computer readable medium 712 at an ATM 726 to withdraw the cash transferred in the secure wire transfer. The withdrawing consumer 704 will need to use the unique security identifier 714 communicated to him by the sender consumer 702 in order to withdraw the cash. During usage of the configured computer readable medium 712 at the ATM 726 or other cash dispersion device, the withdrawing consumer is reminded that the configured computer readable medium is one use only and all the cash in money transfer is presented during the ATM withdraw.

The exemplary computer system 700 of Figure 7 is for descriptive purposes only it may be provided by a microcomputer, a MACINTOSH®or PC server running a WINDOWS NT®, LINUX, UNIX®, or an APPLE® platform. The description is not required to restrict the inventor to one particular form of computer system by which this system would be implemented, but used to illustrate the embodiment.

### COMPUTER METHOD FOR ALTERNATE PREFERRED EMBODIMENT

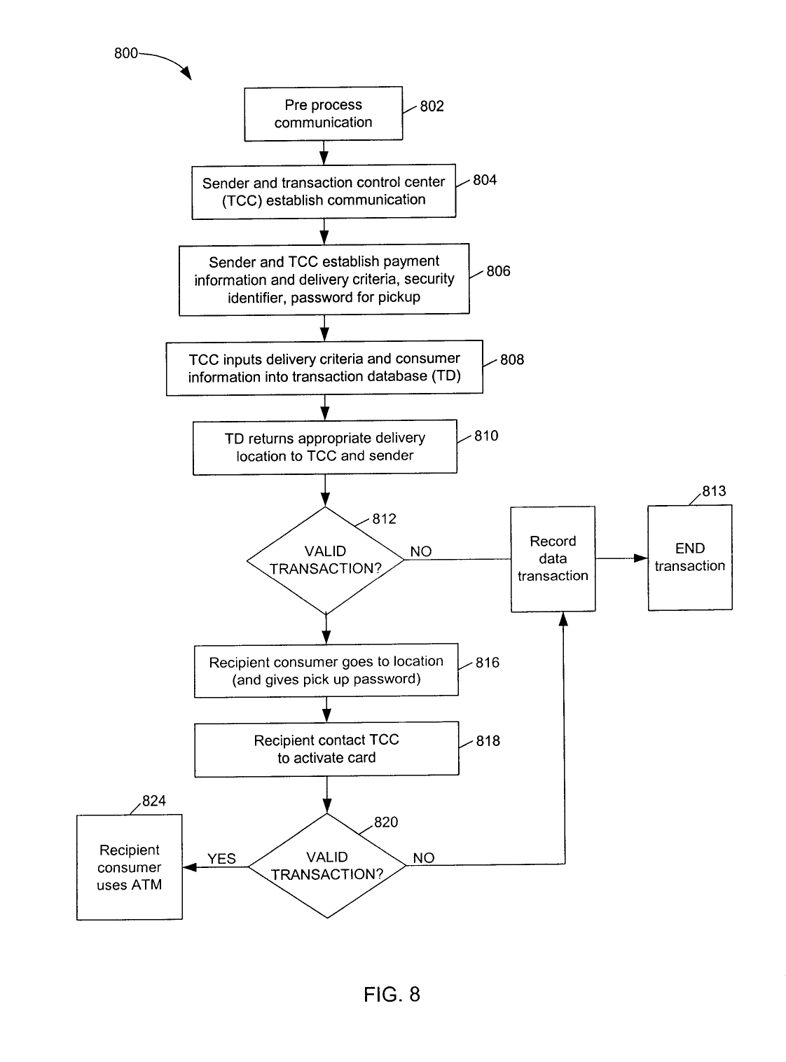

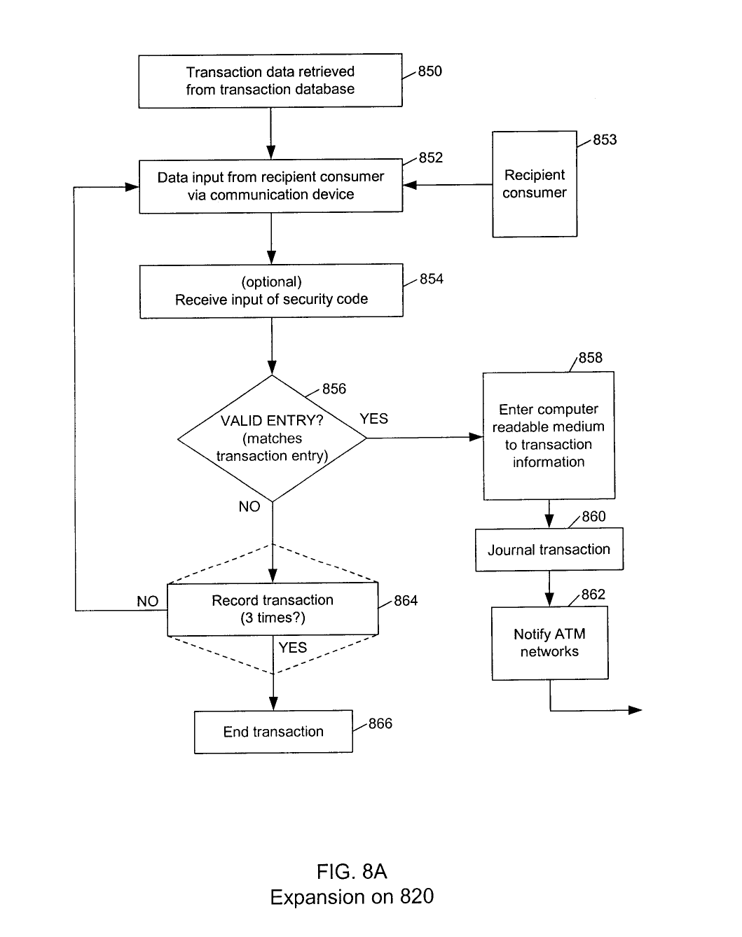

Referring now to figure 8 which is an flowchart of a computer-implemented method for completing an improved secure consumer money transfer as an alternative to a traditional wire transfer. In an initial operation 802, pre-method operations are completed. These operations may include the transferring of computer data to a computer readable medium which enables the computer readable medium to be used by a database connected to an appropriate reading device. This allows the computer readable medium to be read by cash dispensing devices including ATMs.

In operation 804, the sender consumer establishes contact with the transaction control center via an appropriate communications system. In operation 806, the transaction control center and the sender consumer exchange consumer transaction and security code information. An optional pick up password may be exchanged during this operation.

In the operation 808, contact information for said recipient consumer; purchasing information from the sender consumer security identifier associated with said secure money transfer is entered into a transaction database along with other necessary and optional data. Also entered are the delivery parameters as requested by the sending consumer for an appropriate 3rd party commercial vendor location pick up. The transaction database assigns a configured computer readable medium to the secure wire transfer, which is stored on the database for later activation and verification.

In operation 810, the transaction database returns the appropriate location(s) of the third-party commercial vendor according to the input pick-up criteria, returning at least three best options matching the entered criteria.

The credit card transaction is verified by the transaction database in 812. If the transaction is not valid (cancelled card, over credit limit, etc.) the transaction is terminated (813). If the transaction is valid, the transaction database informs the transaction fulfillment center itself or via the transaction control center.

In an optional feature to the invention operation 817, the third party commercial vendor informs the transaction control center that the recipient consumer has not picked up the configured computer readable medium. The transaction control center notifies the transaction database, which deactivates the configured computer readable medium and credits the sender consumer with the unused funds in the transaction. This feature may also be activated automatically by the transaction database as well, with the communication from the third party commercial vendor.

In operation 820, the configured computer readable medium is activated via the transaction database, when the transaction control center receives a request from the recipient consumer to activate the card. The transaction database merges the transaction information from the sender consumer with appropriate information from the configured computer readable medium and then informs a participating financial computer network that the configured computer readable medium is active, allowing the recipient consumer to withdraw cash from ATM networks.

Figure 8A is a detailed description of operation 820. In operation 850 the consumer transaction data is retrieved from the transaction database. In operation 852, the recipient consumer information is entered into the transaction database. This information may include entry of a serial number for the configured computer readable medium in operation 854.

In operation 856, the transaction database executes an algorithm which determines whether the consumer transaction information matches the recipient consumer information by comparing the stored consumer transaction data to a list of valid assigned serial numbers for the configured computer readable medium, and other information, such as pick up location of the configured computer readable medium and security code.

If the computer medium serial number is valid and the other data matches, then the transaction database merges the two sets of data in 858 and records the transaction in operation 860, and then informs a financial network that the configured computer readable medium is now active, in operation 862. If the data does not match, then the transaction database records the transaction in operation 864 and requests new recipient consumer information in operation 852. Alternately, after operation 864 is implemented twice the entire transaction is cancelled in operation 866.

### ALTERNATE PREFERRED EMBODIMENT: Computer Oriented Business Method for an Improved portable electronic draft using a configured computer readable medium (as an alternative to traditional traveler@$apos;s checks) utilizing third party commercial vendor networks.

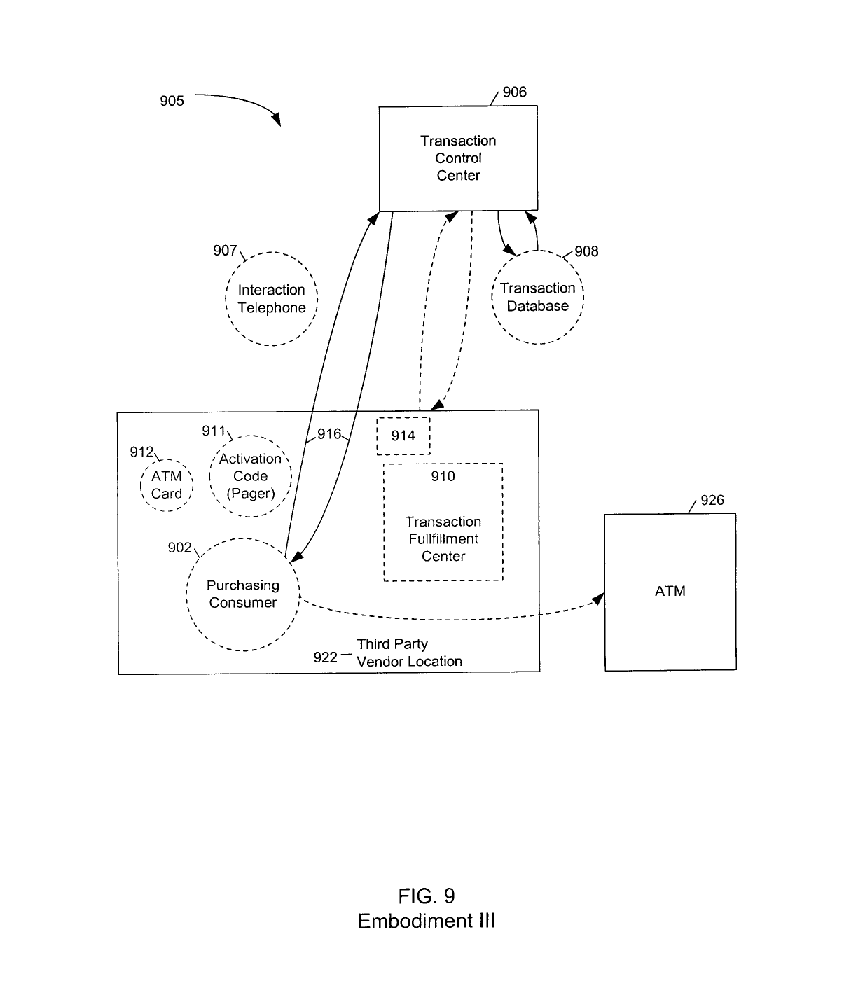

Referring now to Figure 9, illustrated is a computer system by which a purchasing consumer, 902, can obtain a portable electronic draft system utilizing a one time use only configured computer readable medium and a network of third party commercial vendors. Computer system 900 consists of a transaction control center 906, a communications system 914, a transaction database 908, a configured computer readable medium 912, a unique security identifier 916, an optional unique account identifier 911, a network of third party commercial vendors 922, which is ideally open 24 hours a day, 365 days a year and has an on-location pay phone, which will allow a free 1-800 call, and on-location cash dispensing device 926, such as an ATM connected to a financial computer network. Data exchanged between the purchasing consumer and the transaction control center is represented by 905.

A purchasing consumer 902 wishes to buy secure portable electronic drafts in the form of a (one time use) configured computer readable medium, which function as ATM cards. The purchasing consumer goes to the physical location of the third party commercial vendor 922, and acquires a one-time use configured computer readable medium 912 from the vendor, in which may be included an optional unique account identifier 911. These computer readable media may be displayed as merchandise, or the third party commercial vendor may wish to keep these items secure and submit the cards upon request of the purchasing consumer.

The consumer may contact the transaction control center 906, directly via a consumer communication system 907 which may be embodied as a standard telephone communication, such as a vanity 1-800 number, or communication via a web site. The third party commercial vendor may contain transaction fulfillment center 910 on site, which may be connected to the transaction control center 906 via a communication device 914 or the transaction fulfillment center 910 could be in a virtual location instead.

The transaction control center 906 then inquires of the purchaser consumer as to information 905, such as the desired amount of the transaction, the unique security identifier 916 and the optional configured computer readable medium serial number 911. The transaction control center then inputs this data into the transaction database 908.

As an optional feature, the transaction database 908 returns to the transaction control center 906 as to whether that serial number 911 is valid. If the unique account identifier is not valid, appropriate action is taken by the transaction database 908 or the transaction control center 906.

The transaction control center then records the purchaser consumer's transaction information 905, such as name, credit card number, etc. into the transaction database 908.

The credit card transaction between the sending consumer and the transaction control center is also verified by the transaction database 908. If the transaction is valid, the transaction control center sends verification 920 to the transaction database 908, which enables the configured computer readable medium 912 to be used by a network of ATMs 926 or other cash dispersion devices.

The redeeming consumer 904 can now use the configured computer readable medium at an ATM 926 to withdraw the cash. The redeeming consumer 904 will need to use the unique security identifier 916 that they communicated to the transaction control center 906. During usage of the configured computer readable medium 912 at the ATM 926 or other cash dispersion device, the withdrawing consumer 904 is reminded that the configured computer readable medium is a one use only and all the cash in wire transfer is presented during the ATM transaction.

### COMPUTER METHOD FOR ABOVE PREFERRED EMBODIMENT

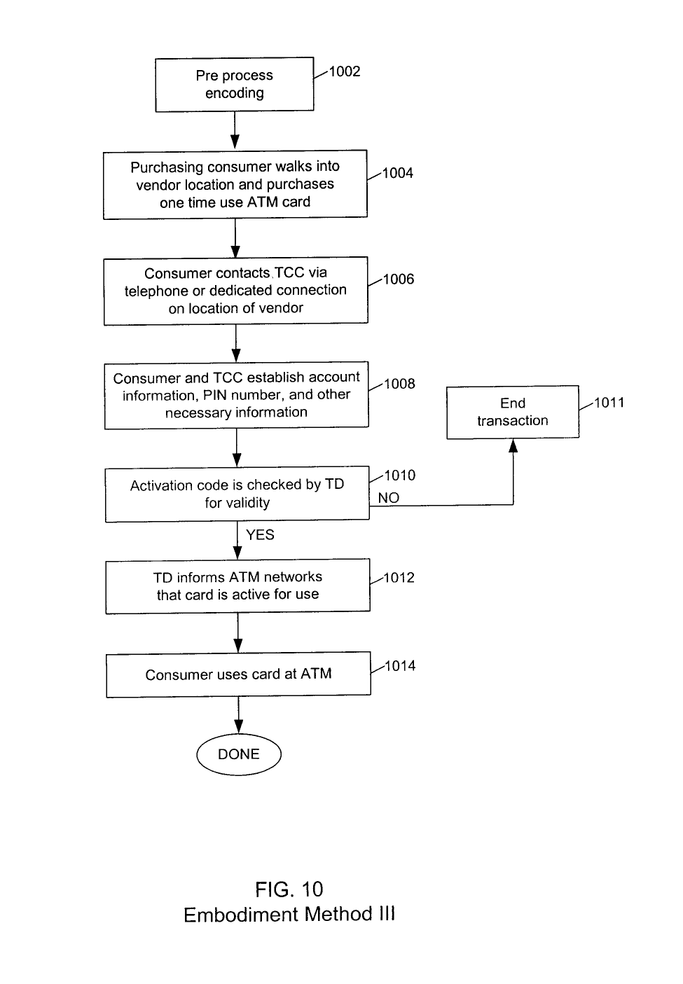

Referring now to Figure 10 which is an flowchart of a computer-implemented method for completing the activation of portable electronic draft. In an initial operation, 1002, pre-method operations are completed. These operations may include the transferring of computer data to a computer readable medium as to enable to the computer readable medium to be utilized by a transactional database connected to an appropriate reading device and to allow the computer readable medium to be read by cash dispensing devices, including ATMs.

In operation 1004, a purchasing consumer walks into a third party commercial vendor location and acquires a one time use configured computer readable medium. In operation 1006 the purchaser consumer establish contact with the transaction control center via an appropriate communications system, which may include a toll free telephone call or an Internet connection.

In the operation 1008, the consumer transaction and unique security identifier information for the purchaser consumer is placed into a transaction database along with other necessary and optional data.

In the optional operation, 1010, the data from the activation code (which is contained with the configured computer readable medium when purchased) is entered into the transaction database. The transaction database then returns the information as to whether that particular configured computer readable medium is valid. If the activation code is not valid the transaction is terminated in 1011.

In operation 1012 the transaction database then informs a participating financial computer network that the configured computer readable medium is active, allowing the recipient consumer to withdraw cash from the appropriate ATM networks.

### Devices utilized for the preferred embodiments

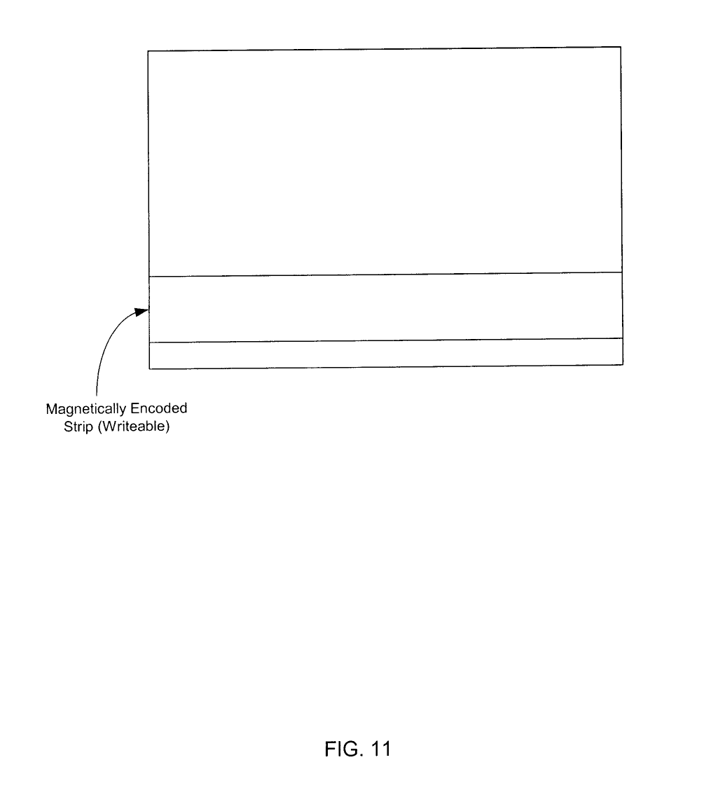

Referring now to Figure 11, disclosed is a one embodiment of the computer readable medium that may be used to implement the present invention. In the embodiment shown, the computer readable medium is a magnetically encoded ATM card. As will be appreciated by those skilled in the art, the data placed onto the said medium (one time use ATM card) may be accomplished through a variety of methods.

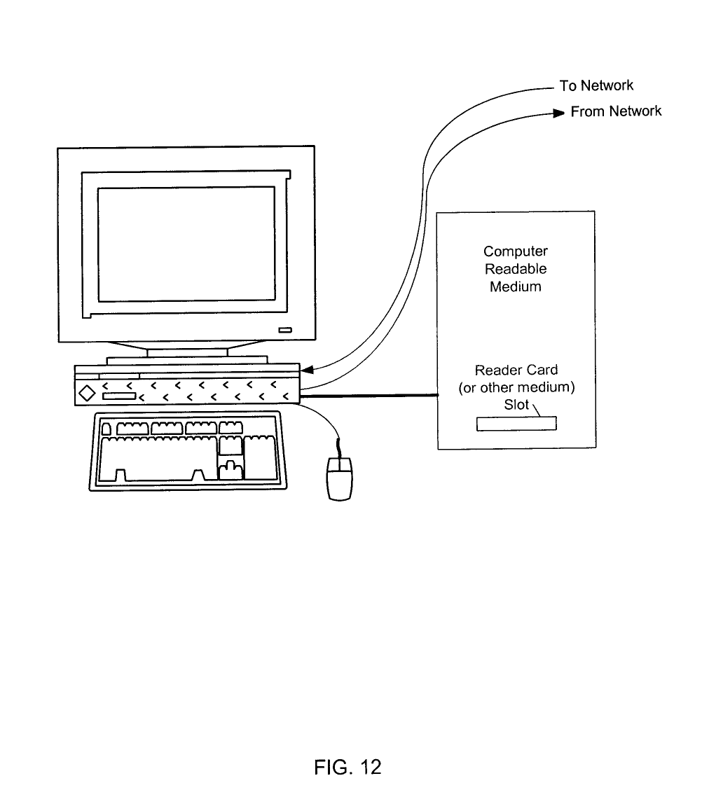

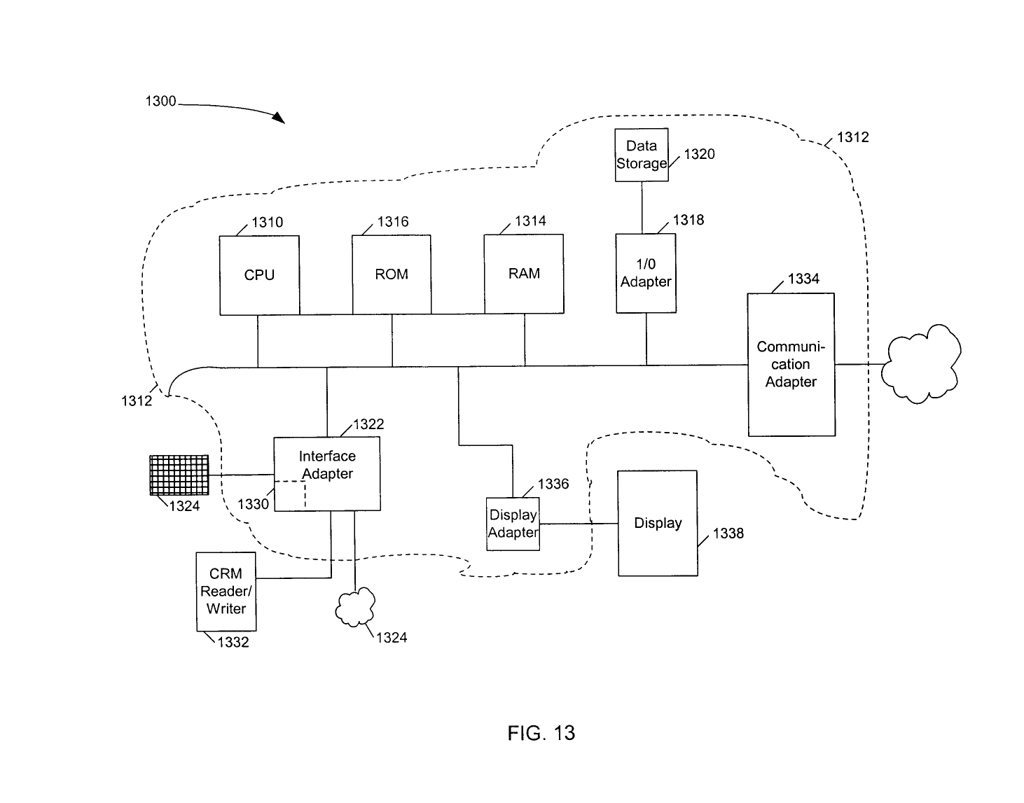

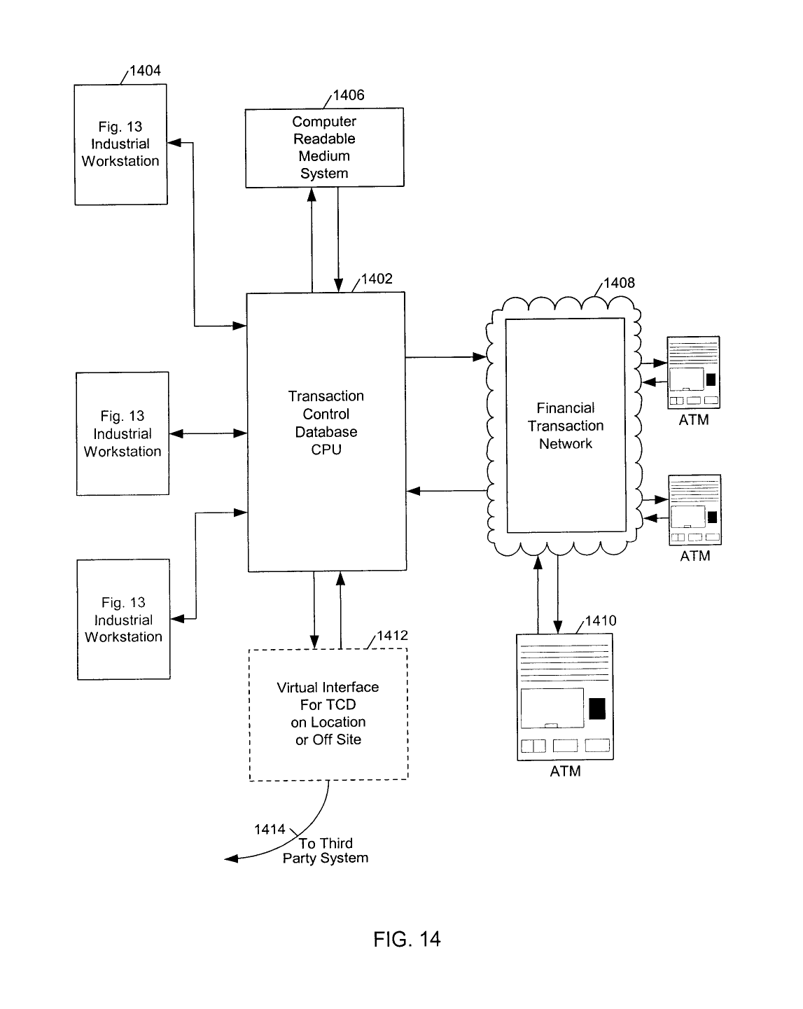

Figure 12 represents a computer readable medium reader 1202, which is attached to a computer (see figure 13) via an appropriate interface 1204. There is a mechanism for inserting the computer readable medium at 1206.

Figure 13 represents a computer system 1300 by which a preferred embodiment of the system may be implemented, including a connection to a computer readable medium reader 1332. Computer system 1300 includes a central processing unit 1310, a housing unit for all the components (commonly referred to as a "computer") 1312, random access memory 1314, read only memory 1316, an input-output adapter for a data storage device 1318, a data storage device 1320, a user interface adapter 1322, a keyboard or other input device 1324, a computer medium reader adapter 1330, computer readable medium reader and encoder 1332, a communications adapter 1334, a computer network connection 1335, a display adapter 1336, and display device 1338.

Figure 14 represents a computer system by which the invention may be utilized in all its preferred embodiments, including an example of how the transaction database can be utilized in the present invention. It consists of a transaction control database (TCD) central unit which will include a CPU 1402, a transaction control database workstations 1420, 1422, 1424, described in drawing 13, in communication with the TCD via LAN, or other suitable connections, a computer readable medium system 1406, which is interaction with the TCD. A financial transaction network 1408, connection to a network of ATMs 1410 A virtual interface which may be on-site or off-site with the TCD 1412, is an optional feature. This optional virtual interface will be optionally connected to a third party vending network 1414.

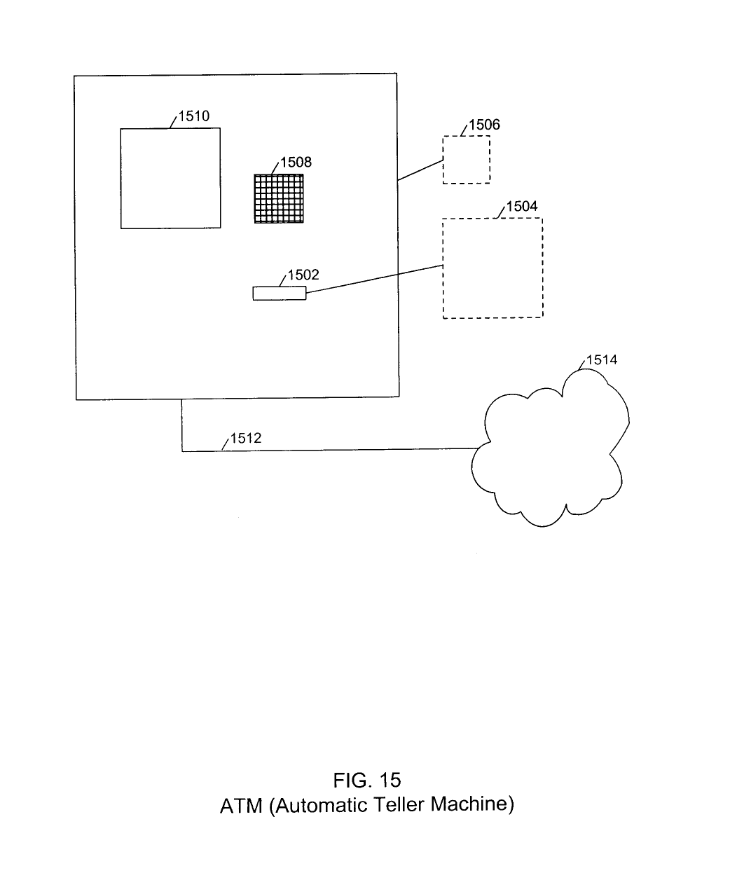

Figure 15 represents an Automatic Teller Machine (ATM), which includes, a magnetically encoded card slot 1502, a card reader 1504, a central processing unit 1506, a keypad for entry of data 1508, a display monitor for relaying information to a consumer 1508, and a connection device 1510 that communicates with financial networks 1512 connected to other ATMs.

Claims

1. A computer system to facilitate secure money transfer transactions between sender consumers and recipient consumers, said computer system comprising:
a transaction control center for receiving information from a sender consumer in order to initiate a secure money transfer with a recipient consumer;
a computer readable medium configured to enable the completion of a secure money transfer when utilized by a recipient consumer;
a transaction database configured to store transaction data associated with said secure money transfer, said transaction data associated with said secure money transfer including consumer transaction information, a delivery address through which said recipient consumer can obtain said configured computer readable medium, and a unique security identifier for said secure money transfer, said transaction database being in communication with said transaction control center; and
a transaction fulfillment center being in communication with said transaction control center, said transaction fulfillment center controlling delivery of said computer readable medium utilized by said recipient consumer to complete said secure money transfer.

2. A computer system as recited in claim 1, wherein said transaction control center includes a telemarketing operation capable of receiving a secure money transfer telephone order from said sender consumer.

3. A computer system as recited in claim 1, wherein said transaction control center includes an Automated Teller Machine (ATM) machine capable of processing a secure money transfer order.

4. A computer system as recited in claim 1, wherein said transaction control center includes a web site available on the Internet for processing a secure money transfer on-line order from said sender consumer.

5. A computer system as recited in claim 1, wherein said transaction database conveys information to said transaction control center that said delivery address of the recipient consumer is the address of one of a network of third party commercial vendors who will hold the configured computer readable medium for the recipient consumer for pick up.

6. A computer system as recited in claim 1, further comprising a network of participating third party commercial vendors. and wherein the transaction fulfillment center is located at the physical location of one of a network of participating third party commercial vendors.

7. A computer system as recited in claim 1, further comprising a toll free telephone communication line between the recipient consumer and the transaction control center. and wherein the configured computer readable medium is activated by the recipient consumer via said toll free telephone communication with the transaction control center.

8. A computer system as recited in claim 1, further comprising Internet communication between the recipient consumer and the transaction control center. and wherein the configured computer readable medium is activated by the recipient consumer via said Internet communication with the transaction control center.

9. A computer system as recited in claim 1, wherein the computer readable medium is configured by storing a pre-assigned serial number associated with consumer transaction information.

10. A computer system as recited in claim 6, wherein the physical location of the third party commercial vendor network is always available to the recipient consumer.

11. A computer system as recited in claim 6, wherein the physical location of the third party commercial vendor network includes an ATM on the physical premises.

12. A computer implemented method for facilitating a secure money transfer transaction between a sender consumer and a recipient consumer, said computer implemented method comprising the steps of:
a) obtaining transaction payment information associated with said sender consumer;
b) obtaining delivery address information for said recipient consumer;
c) defining a unique security identifier associated with said secure money transfer;
d) entering the information in steps a)-c) into the transaction database
e) assigning a serial number to the consumer transaction and information and
f) configuring a computer readable medium to said secure money transfer, said computer readable medium utilized by said recipient consumer in completing said secure money transfer and;
g) providing said recipient consumer with said unique security identifier and;
h) providing said configured computer readable medium to the recipient consumer
i) enabling the recipient consumer to withdraw cash from financial networks using said configured computer readable medium and the unique security identifier,.

13. A computer implemented method as recited in claim 12, wherein said act of determining transaction payment information comprising the acts of
obtaining sender consumer 's credit card information or sender consumer 's debit card information;
obtaining a value amount for said secure money transfer;
obtaining authorization for said value amount via sender consumer 's credit card account or sender consumer 's debit card account.

14. A computer implemented method as recited in claim 12, wherein the said act of determining contact information for said recipient consumer includes the act of selecting the most appropriate delivery location by implementing an algorithm that returns the most appropriate delivery location based on criteria, comprising but not limited to: (a) the geographic location of recipient consumer, (b) the desired hours of pick-up location, and (c) the desired features of pick-up location.

15. A computer implemented method as recited in claim 12, wherein the said act of facilitating the withdrawal of cash by a recipient consumer configured computer readable medium further comprises the acts of
(a) entering the consumer transaction data in a transaction database.
(b) entering the recipient consumer request into a transaction database, which may include a serial number for a configured computer readable medium.
(c) comparing the recipient consumer information with the stored consumer transaction data to determine if the recipient consumer information matches the consumer transaction information
(d) if there is a match, then the transaction database associates the recipient consumer information with the consumer transaction data records the transaction. and signals a financial network that the configured computer readable medium is enabled to withdraw cash from ATM networks.
(e) if there is not a match the consumer transaction information then the transaction database requests new information from the recipient consumer in step b.

16. A computer implemented method as recited in claim 12, wherein said recipient consumer contact information includes a recipient consumer delivery address.

17. A computer implemented method as recited in claim 16, wherein said recipient consumer delivery address is said recipient consumer 's mailing address.

18. A computer implemented method as recited in claim 16, wherein said recipient consumer delivery address indicates a commercial enterprise that permits walkin pick-up of said configured computer readable medium by said recipient consumer.

19. A computer implemented method as recited in claim 18, wherein a sender consumer provides a security pickup password to the transaction control center. in which the recipient consumer must present security pick up password to the commercial enterprise in order to receive the configured computer readable medium.

20. A computer implemented method as recited in claim 12, wherein said acts a) - c) are accomplished via a telephone communication between said sender consumer and a transaction control center. said transaction control center maintaining said consumer transaction information, said recipient consumer contact information, and said unique security identifier.

21. A computer implemented method as recited in claim 13, wherein said acts a) - c) are accomplished via a global computer network communication between said sender consumer and a transaction control center said transaction control center maintaining said consumer transaction information, said recipient consumer contact information, and said unique security identifier.

22. A computer implemented method as recited in claim 12, wherein said unique security identifier is provided by said sender consumer.

23. A computer implemented method as recited in claim 16, wherein said unique security identifier is provided by said sender consumer.

24. A computer implemented method as recited in 12 wherein a recipient consumer activates said configured computer readable medium by conveying information through a voice communication contact.

25. A computer implemented method as recited in claim 12 by which a recipient consumer activates a configured computer readable medium by conveying information through a data transmission.

26. A computer implemented method as recited in 18 wherein a recipient consumer activates said configured computer readable medium by conveying information through a voice communication contact.

27. A computer implemented method as recited in 18 by which a recipient consumer activates a configured computer readable medium by conveying information through a data transmission.

28. A method for using a magnetically encoded card compatible for use in a credit or debit card mediated financial transaction networks, to facilitate secure money transfers to a party, said method comprising using a debit card delivered to a recipient consumer after purchase by a sender consumer.

29. The method as recited in claim 28, wherein said magnetically encoded card contains a serial number.

30. The method as recited in claim 29, wherein the serial number is printed on said card.

31. The method as recited in claim 29, wherein the serial number is encoded in the magnetic strip of said card.

32. The method as recited in claim 29, wherein said serial number is contained in packaging with said card.

33. The method as recited in claim 28, wherein said magnetically encoded card may be purchased by a consumer for use as a portable electronic draft.

34. The method as recited in claim 28 by which a purchaser consumer may enable said card by communicating to a transaction control center that the purchaser consumer is in possession of the magnetically encoded card.

35. The method as recited in claim 29 by which a purchaser consumer may activate said card by communicating to a transaction control the serial number associated with said card.

36. A computer implemented method as recited in claim 26, where the said act of activation of a configured computer readable medium includes the steps of
a). entering the activation request of a recipient or purchaser consumer into a transaction database which may include the configured computer readable medium serial number.
b). determining the validity of the activation request by a recipient consumer.
c). if the activation request of the recipient consumer is valid then the transaction database informs the financial network that the configured computer readable medium is active.
d). if the activation request of the recipient consumer is not valid, then the transaction database requests new recipient or purchaser consumer information as recited in step a).

37. A computer implemented method as recited in 27, where the said act of activation of a configured computer readable medium includes the steps of
a). entering the activation request of a recipient or purchaser consumer into a transaction database which may include the configured computer readable medium serial number.
b). determining the validity of the activation request by a recipient consumer.
c). if the activation request of the recipient consumer is valid. then the transaction database informs the financial network that the configured computer readable medium is active.
d). if the activation request of the recipient consumer is not valid, then the transaction database requests new recipient or purchaser consumer information as recited in step a.)

38. A computer system intended to enable for the purchase of a secure portable electronic draft in the form of a configured computer readable medium. Said computer system comprising of:
a transaction control center operative for receiving information from a purchaser consumer in order to initiate activation of a secure portable electronic draft using a configured computer readable medium;
a computer readable medium configured to enable the redemption of a portable electronic draft; and
a transaction database configured to store transaction data associated with said secure portable electronic draft purchase, said transaction data associated with said purchase including consumer transaction information, a unique security identifier for said redemption of a portable electronic draft, said transaction database being in communication with said transaction control center; and
a transaction fulfillment center, said transaction fulfillment center controlling delivery of said configured computer readable medium.

39. A computer system as recited in claim 38, wherein the configured computer readable medium has an assigned serial number.

40. A computer system as recited in claim 38, wherein the transaction fulfillment center is located at the physical location of a third party commercial vendor.

41. A computer system as recited in claim 38, wherein the physical location of the third party commercial vendor is always available to a purchaser consumer.

42. .A computer system as recited in claim 38, wherein the physical location of the of the third party commercial vendor has an ATM on the physical premises.

43. A computer system as recited in claim 38, wherein the physical location of the of the third party commercial vendor network has a dedicated communication system in communication with the transaction control center.

44. A computer implemented method for facilitating purchase of a portable electronic draft and redemption of said portable electronic draft by a purchaser consumer. said computer implemented method comprising the steps of:
a). obtaining transaction payment information associated with said purchaser consumer;
b). obtaining a unique security identifier associated with said portable electronic draft purchase;
c). entering the information in steps a)-.b) into the transaction database
d). assigning a serial number to the consumer transaction information
e). configuring a computer readable medium to said portable electronic draft purchase and redemption. said computer readable medium utilized by said purchaser consumer in redeeming the portable electronic draft;
f). providing a purchaser consumer with a unique security identifier of the consumer's choosing; and
g). providing the means by which the purchaser consumer can withdraw cash assigned to the portable electronic draft from financial networks using the configured computer readable medium

45. A computer implemented method as recited in 44, wherein the purchaser consumer purchases the configured computer readable medium as a gift card for a third party.

46. An automated process for sending money from a first location to a second location comprising:
receiving a request for a secure money transfer from a requestor;
receiving information associated with a recipient for said secure money transfer;
receiving information indicating an amount of said secure money transfer;
transferring said amount to a secure money transfer instrument;
assigning an authorization to said secure transfer instrument; and
providing information enabling receipt of said secure money transfer instrument by said recipient, wherein said authorization enables said recipient to use said secure money transfer instrument.

47. The process of claim 46 wherein said secure money transfer instrument is a card for use in automated teller machines.

48. The process of claim 47 wherein said authorization includes an access code for use with said automated teller machines in order to receive money.

49. The process of claim 46 further comprising providing said authorization to said recipient, wherein said authorization is provided independently of said secure transfer instrument.

50. The process of claim 46 wherein said secure money transfer is used to transfer money from said requestor located in a first country to said recipient located in a second country, and wherein said requestor may allocate additional money to said secure money transfer instrument via a communications network.

51. An automated process for sending money from a first location to a second location comprising:
receiving a request for a secure money transfer from a requestor indicating a destination for said transfer and an amount for transfer via a communications network;
assigning said amount to an atm card;
assigning an authorization code to said atm card;
providing said atm card to said destination such that a recipient receives said atm card enabling said recipient to withdraw funds from an automated teller machine using said atm card, wherein additional amounts may be assigned to said atm card by said requestor for retrieval by said recipient.

52. The process of claim 51 further comprising:
receiving an additional request from said requestor via said communications network indicating a sum of money to be added to said atm card for retrieval by said recipient using said atm card.

53. The process of claim 51 wherein said destination is the address of said recipient.

54. An automatic money transfer system for transferring money from a donor to a donee comprising:
an automated server system for facilitating the secure transfer of money from a donor to a donee, said automated server system being operative to allocate funds to a portable secure transfer instrument and to assign a security code to said instrument, said secure transfer instrument including machine readable information;
a data storage device for recording said secure transfer; and
a delivery system for providing said portable secure transfer instrument to said donee enabling said donee to access said funds from an automated teller machine using said portable secure transfer instrument and said security code.

55. The system of claim 53 wherein said security code is contained in said machine readable information.

56. The system of claim 53 wherein said security code must be manually entered on said automated teller machine by said donee in order for said donee to receive money.

57. The system of claim 53 further comprising an automated communications system for providing said security code to said donee via a communications network.

58. The system of claim 50 wherein said amount is provided by said requestor in a first currency and provided to said recipient in second currency, wherein said first currency and said second currency are of different nationalities.
